(19) United States
(12) Patent Application Publication
(10) Pub. No.: US 2021/0002521 A1
(43) Pub. Date: Jan. 7, 2021

(54) THERMALLY CURING ADHESIVE AND ADHESIVE TAPE PRODUCED THEREFROM

(71) Applicant: tesa SE, Norderstedt (DE)

(72) Inventors: Uwe Schümann, Pinneberg (DE); Nicholas Buggy, Attwood (AU); Sebastian Dietze, Kaltenkirchen (DE); Kim Elsenbach, Bargteheide (DE)

(73) Assignee: tesa SE, Norderstedt (DE)

(21) Appl. No.: 16/919,393

(22) Filed: Jul. 2, 2020

(30) Foreign Application Priority Data
Jul. 3, 2019 (DE) 10 2019 209 754.5

(51) Int. Cl. C09J 109/02; C09J 7/35; C09J 7/29

(52) U.S. Cl. CPC C09J 109/02; C09J 7/29; C09J 7/35

(57) ABSTRACT

An adhesive, more particularly a thermally curable, meltable, preferably pressure-sensitive adhesive, which is curable thermally from a temperature of 110° C., is storage-stable for approximately one month at 60° C. and longer than one year at 23° C., and an adhesive tape produced therefrom, comprising an epoxide-functionalized acrylonitrile/butadiene copolymer having on average more than 1.5 epoxide groups per molecule, and the ground reaction product of phthalic anhydride and diethylenetriamine, for use in the automotive industry both in bodyshell construction on oiled metal sheets and in the coating line on cathodically electrocoated or otherwise-coated metal sheets, for bonding and/or sealing, for example for hem fold bonding, for hem fold sealing, for seam sealing, for underseal bonding, for hole stopping, and much more.

### CROSS-REFERENCE TO RELATED APPLICATIONS

This application claims the benefit of priority under 35 U.S.C. § 119 of German Patent Application No. 10 2019 209 754.5, entitled THERMALLY CURING ADHESIVE AND ADHESIVE TAPE PRODUCED THEREFROM, filed Jul. 3, 2019, the contents of which are relied upon and incorporated herein by reference in their entirety.

### FIELD OF THE DISCLOSURE

The present disclosure relates to a preferably pressure-sensitive adhesive, meltable, high-strength, one-component (1K) adhesive which is storage-stable at room temperature, thermally curable from 110° C. and tough and elastic after curing, to a method for producing same, to an adhesive tape comprising this adhesive, and to a method for producing the adhesive tape. The disclosure can be used wherever process temperatures between 110° C. and 230° C. are available. The disclosure may therefore be used as adhesive tape or sealing tape or as part of an adhesive tape or sealing tape in the automotive industry, in bodyshell construction for application to oiled sheets, or in the painting process for application to painted sheets, for example to cathodically electrocoated sheets. In particular, the disclosure can also be utilized in areas in which process temperatures of 110° C. cannot or must not be exceeded. This may be the case for the bonding of temperature-sensitive components, such as certain plastics, for example.

### BACKGROUND

Thermally curing adhesives and adhesive tapes which can be produced from them are well known. For example, WO 2018059931A1 describes a thermally vulcanizable, meltable, preferably pressure-sensitive adhesive and an adhesive tape produced from it. A disadvantage for some uses is that the curing begins only from around 130° C.

DE 10 2013 217 880 A1 describes latent-reactive adhesive products with onset temperatures from 40° C., based on a layer of a latent-reactive adhesive film, which comprises a thermoplastic component, with functional groups able to react with isocyanate, and an isocyanate-containing component, which is present in a form dispersed as particles into the thermoplastic component and which is blocked, microencapsulated or substantially deactivated in the region of the particle surface. A disadvantage here for some uses is that these adhesive products are not pressure-sensitive adhesives.

For the thermal curing of a one-component adhesive (also referred to hereinafter as 1K epoxy adhesive) at relatively moderate temperatures, U.S. Pat. No. 4,459,398 proposes the use of the reaction product of diethylenetriamine with phthalic anhydride, available from Ciba Geigy under the tradename HY 939, in combination with dicyandiamide and the complex of an imidazole with a metal salt. The storage stability is said to be several months and the cure time to be less than 4 minutes at 130° C. to 150° C. Claim 1 of that specification always has bisphenol A diglycidyl ether among the epoxides to be cured, as well as a flexibilizing epoxide.

EP 0289632 A1 as well proposes the use of the reaction product of diethylenetriamine with phthalic anhydride in combination with dicyandiamide for the curing of bisphenol A diglycidyl ether resins, the curing in this case taking place inductively. A storage stability of at least two weeks at temperatures of up to 41° C. is stated. At temperatures of up to 150° C., the formulations in this specification are said to be non-reactive. Epoxides in the examples of this specification are preponderantly always bisphenol A diglycidyl ethers.

EP 1876194 A1 proposes heat-curing compositions which comprise at least one epoxy resin A having on average more than one epoxide group per molecule, at least one impact modifier B, at least one crack promoter C, and at least one curing agent D for epoxy resins; in one example, under the tradename Aradur HT 939 EN, the reaction product of diethylenetriamine with phthalic anhydride (CAS No.: 68003-28-1) is used as crack promoter C in combination with inter alia a liquid rubber, a urea derivative and a blocked polyurethane as impact modifier and also bisphenol A diglycidyl ether as epoxy resin and dicyandiamide as a curing agent.

In order to obtain toughness with elasticity, or toughness, numerous specifications disclose the use of functionalized acrylonitrile/butadiene copolymers or nitrile rubbers—for example, EP 381625 B1, EP 245018 B1, DE 4001417 A1, EP 1527147 B1, EP 1578838 B1, EP 1 819 793 B1, EP 2084199 B1, EP 2084203 B1, EP 2161274 B1, EP 2182025 B1, EP 2730594 A1, EP 2917254 B1, EP 2986685 B1, U.S. Pat. No. 4,661,539, U.S. Ser. No. 10/150,897 B2, US 20170081571 A1, WO 2004067664, WO 2014072426 A1, WO 201 41 721 28 A, to give just a small selection. The functionalization is frequently a carboxyl group, although hydroxyl, amino, acrylate or epoxide functions are common as well. Adhesive formulations which are storage-stable at room temperature and cure rapidly from as low as 110° C. are not presented in these specifications.

The above-cited specification EP 1876194 A1 describes not only the reaction product of diethylenetriamine with phthalic anhydride, which is used therein as a crack promoter, but also functionalized acrylonitrile/butadiene copolymers, as known impact modifiers. A formula containing both substances at the same time is not presented. Commercially available functionalized acrylonitrile/butadiene copolymers are, for example, the Hypro® products from CVC/Emerald Performance Materials (formerly Hycar® from BF Goodrich), or the Struktol® Polydis range from Schill+Seilacher.

It is therefore an object of the invention to provide an adhesive, preferably a pressure-sensitive adhesive, and also an adhesive tape comprising such an adhesive, being curable thermally within a temperature range from 110° C. to 230° C., so that the adhesive and the adhesive tape can be used in the automotive industry both in bodyshell construction on oiled metal sheets and in the coating line on cathodically electrocoated or otherwise-coated metal sheets, for bonding and/or sealing, for example for hem fold bonding, for hem fold sealing, for seam sealing, for underseal bonding, for hole stopping, and much more. In particular, however, the invention is also to be able to be utilized in areas in which process temperatures of 110° C. cannot or must not be exceeded, for example for the bonding of temperature-sensitive substrates, such as certain plastics, for instance. The lap shear strengths achievable with the adhesive ought to extend into the region of around 20.0 N/mm². The adhesive is to be able to be produced in a compounding and extrusion process within a temperature range from 40° C. to 60° C. Within this latter temperature range, the base elastomer of this adhesive must be present as a melt. During the processing in melt form or during the subsequent storage at temperatures of up to 60° C., there must be no onset of the curing reaction or any other crosslinking reaction. In the temperature range from room temperature (20° C.-25° C., ideally 23° C.) to 30° C., the adhesive must be sufficiently solid or of high viscosity, allowing it to be wound into a roll, as a film coated onto a release liner or as a film coated onto a carrier material, without the adhesive running out of the side or being squeezed out by the pressure of winding.

### SUMMARY OF THE DISCLOSURE

According to an aspect of the disclosure, an adhesive is provided that includes: an epoxide-functionalized acrylonitrile/butadiene copolymer having on average more than 1.5 epoxide groups per molecule; and a reaction product of phtalic anhydride and diethylenetriamine. Further, the reaction product is in ground form. In addition, the adhesive is meltable and thermally curable.

According to another aspect of the disclosure, an adhesive is provided that includes: an epoxide-functionalized acrylonitrile/butadiene copolymer having on average more than 1.5 epoxide groups per molecule; and a reaction product of phtalic anhydride and diethylenetriamine. The reaction product is in ground form. In addition, the adhesive is meltable between 40° C. and 60° C. and thermally curable between 110° C. and 230° C. Further, a ratio of the number of NH bonds in the reaction product of phthalic anhydride and diethylenetriamine to the total number of epoxide groups is between 0.1 and 1.5, as determined by using a theoretical equivalent weight of 77.7 g per mol of the NH bonds.

According to a further aspect of the disclosure, an adhesive tape is provided that includes: at least one carrier layer, the carrier layer comprising a woven fabric, a nonwoven, a paper or a film; and an adhesive. Further, the adhesive includes: an epoxide-functionalized acrylonitrile/butadiene copolymer having on average more than 1.5 epoxide groups per molecule; and a reaction product of phtalic anhydride and diethylenetriamine. The reaction product is in ground form. In addition, the adhesive is meltable between 40° C. and 60° C. and thermally curable between 110° C. and 230° C. Further, a ratio of the number of NH bonds in the reaction product of phthalic anhydride and diethylenetriamine to the total number of epoxide groups is between 0.1 and 1.5, as determined by using a theoretical equivalent weight of 77.7 g per mol of the NH bonds.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims.

The object of the disclosure can be achieved by an adhesive, more particularly a thermally curable, meltable, preferably pressure-sensitive adhesive, comprising an epoxide-functionalized acrylonitrile/butadiene copolymer having on average more than 1.5 epoxide groups per molecule, and the ground reaction product of phthalic anhydride and diethylenetriamine.

The present disclosure relates more particularly to a thermally curable adhesive which at room temperature has a solid or at least very high-viscosity consistency and is preferably pressure-sensitive adhesive, can be processed as a melt in a compounding and extrusion process in a temperature range between approximately 40° C. and 60° C., and cures thermally in a temperature range between 110° C. and 230° C. The curing thus achieved entails a chemical crosslinking and so after the curing the adhesive is no longer meltable.

An epoxide-functionalized acrylonitrile/butadiene copolymer having on average more than 1.5 epoxide groups per molecule is understood in this specification to be a copolymer of acrylonitrile and butadiene onto which the corresponding number of epoxide groups has been chemically attached. Preferably two epoxide groups per molecule are chemically attached. The chemical attachment is generally accomplished by starting from a carboxyl-functionalized, usually carboxyl-terminated copolymer of acrylonitrile and butadiene (CAS number: 68891-46-3), which is reacted either with an epoxide, for example with bisphenol A diglycidyl ether (DGEBA) or with bisphenol F diglycidyl ether (DGEBF) or with a bisphenol A-epichlorohydrin resin with an average molar mass 700 g/mol (CAS number: 25068-38-6) or with a bisphenol F-epichlorohydrin resin (CAS number: 9003-36-5), or with epichlorohydrin. Carboxyl-terminated copolymers of acrylonitrile and butadiene are available commercially under the tradename Hypro® and the ending CTBN from CVC/Emerald Performance Materials. The epoxide-functionalized acrylonitrile/butadiene copolymers prepared from them are available from the same company likewise under the tradename Hypro® and carry the ending ETBN. They are additionally obtainable from Schill+Seilacher under the tradename Struktol® Polydis. Also available there under the same tradename are the particularly advantageous products chain-extended with bisphenol A and bisphenol F, and also the epoxide-functionalized, precrosslinked nitrile rubbers, which can likewise be used.

The reaction product of phthalic anhydride and diethylenetriamine has the CAS number: 68003-28-1. It is available in ground form under the tradename ARADUR® 9506 from Huntsman. The free diethylenetriamine content, advantageously and in accordance with the specification of ARADUR® 9506, is between 1.0 and 5.0 weight percent inclusive. The particle size is advantageously (and also according to specification of ARADUR® 9506) to an extent of at least 95 weight percent less than or equal to 70 μm in diameter (ascertained by static laser light scattering (laser diffraction technique, ISO 13320:2009); because the cut-off limit is 70 μm, there is no need for specification according to Mie or Fraunhofer theory).

The epoxide-functionalized acrylonitrile/butadiene copolymer having on average more than 1.5 epoxide groups per molecule and the ground reaction product of phthalic anhydride and diethylenetriamine are present in the adhesive of the disclosure advantageously in a defined ratio. This defined ratio is selected such that the number of NH bonds in the ground reaction product of phthalic anhydride and diethylenetriamine relative to the total number of epoxide groups is between 0.1 and 1.5 inclusive, preferably between 0.3 and 1.2 inclusive, more preferably between 0.5 and 0.9, the basis for calculating these ratios for the reaction product of phthalic anhydride and diethylenetriamine being a theoretical equivalent weight of 77.7 g per mol of NH bonds.

A meltable adhesive in the sense of this specification has a complex viscosity, measured with a rheometer in an oscillation test under a sinusoidally oscillating shearing stress in a plate/plate arrangement at a temperature of 23° C. and an oscillation frequency of 10.0 rad/s, of at least 1000 Pas, preferably at least 2000 Pas, ideally at least 3000 Pas. At temperatures in the range between 40° C. and 60° C. and an oscillation frequency of 10.0 rad/s, the complex viscosity reduces to less than 500 Pas, preferably down to less than 200 Pas, ideally down to less than 100 Pas. The oscillation frequency corresponds to the angular frequency.

The complex viscosity η* is defined as follows: η*=G*/ω, where G*=complex shear modulus, and ω=angular frequency. The further definitions are as follows: G*=√(G′)²+(G″)², where G″=viscosity modulus (loss modulus), and G′=elasticity modulus (storage modulus); G″=τ/γ·sin(δ), where τ=shear stress, γ=deformation, and δ=phase angle=phase shift between shear stress vector and deformation vector; G′=τ/γ·cos(δ), where τ=shear stress, γ=deformation, and δ=phase angle=phase shift between shear stress vector and deformation vector; and ω=2π·f (f=frequency).

Pressure-sensitive adhesiveness is that property of a substance which enables it to enter into a durable bond to a substrate even under relatively weak applied pressure. Substances possessing this property are referred to as pressure-sensitive adhesives (PSAs). PSAs are long-established. Frequently they can be detached from the substrate again after use, substantially without residue. At room temperature, in general, PSAs have a permanent inherent adhesiveness, thus having a certain viscosity and tack, so that they wet the surface of the particular substrate even under low applied pressure. The capacity of a PSA to adhere to materials and to transmit forces derives from the adhesion capacity and the cohesion of the PSA.

PSAs may be considered to be liquids of extremely high viscosity with an elastic component. PSAs accordingly have particular, characteristic viscoelastic properties, which result in the permanent inherent tack and adhesiveness. The characteristic of PSAs is that when they are mechanically deformed, there are processes of viscous flow and there is also development of elastic forces of resilience. The two processes have a certain relationship to one another in terms of their respective proportion, depending not only on the precise composition, the structure and the degree of crosslinking of the respective PSA, but also on the rate and duration of the deformation and on the temperature.

The proportional viscous flow is necessary for the achievement of adhesion. Only the viscous components, brought about by macromolecules with relatively high mobility, permit effective wetting and flow onto the substrate where bonding is to take place. A high viscous flow component results in high tack (also referred to as surface stickiness) and hence often also in a high peel adhesion. Highly crosslinked systems, crystalline polymers or polymers with glasslike solidification lack flowable components and are therefore in general devoid of pressure-sensitive adhesiveness or at least possess only little pressure-sensitive adhesiveness.

The proportional elastic forces of resilience are necessary for the attainment of cohesion. They are brought about, for example, by very long-chain macromolecules with a high degree of coiling, and also by physically or chemically crosslinked macromolecules, and may permit the transmission of the forces that act on an adhesive bond. As a result of these forces of resilience, an adhesive bond is able to withstand a long-term load acting on it, in the form of a long-term shearing load, for example, to a sufficient extent over a relatively long time period.

For more precise description and quantification of the extent of elastic and viscous components, and also of the proportion of the components relative to one another, the variables of storage modulus (a) and loss modulus (G″) can be employed, and may be determined by means of dynamic mechanical analysis (DMA). G′ is a measure of the elastic component, and G″ a measure of the viscous component, of a substance. The two variables are dependent on the deformation frequency and the temperature.

The variables can be determined with the aid of a rheometer. In that case, for example, the material under investigation, in the form of a plane-parallel layer, is exposed in a plate/plate arrangement to a sinusoidally oscillating shearing stress. In the case of instruments operating with shear stress control, the deformation is measured as a function of time, and the time offset of this deformation relative to the introduction of the shearing stress is recorded. This time offset is referred to as phase angle δ. The storage modulus G′ is defined as follows: G′=(τ/γ)*cos(δ), where τ=shear stress, γ=deformation, and δ=phase angle=phase shift between shear stress vector and deformation vector. The definition of the loss modulus G″ is as follows: G″=(τ/γ)*sin(δ), where τ=shear stress, γ=deformation, and δ=phase angle=phase shift between shear stress vector and deformation vector.

A substance and the layer produced from it are deemed in general to be a pressure-sensitive adhesive, and are defined as a pressure-sensitive adhesive for the purpose of this specification, if at room temperature, here by definition at 23° C., in the deformation frequency range from 10⁰ to 10¹ rad/sec, G′ is located at least partly in the range from 10³ to 10⁷ Pa and if G″ likewise is located at least partly within this range. Partly means that at least a section of the G′ curve lies within the window formed by the deformation frequency range from 10⁰ inclusive up to 10¹ inclusive rad/sec (abscissa) and also by the range of G′ values from 10³ inclusive up to 10⁷ inclusive Pa (ordinate), and when at least a section of the G″ curve is likewise located within this window. Within this region, which in a matrix plot of G′ and G″ (G′ plotted as a function of G″) may also be referred to as the viscoelastic window for PSA applications or as the PSA window according to viscoelastic criteria, there are in turn different sectors and quadrants which characterize more closely the PSA properties to be expected from the associated substances. Within this window, substances with high G″ and low G′ are notable, for example, in general for high peel adhesion and for low shear strength, whereas substances with high G″ and high G′ are notable both for high peel adhesion and for high shear strength. More generally, the knowledge about the relationships between rheology and pressure-sensitive adhesiveness is described for example in “Satas, Handbook of Pressure Sensitive Adhesive Technology”, Third Edition, (1999), pages 153 to 203, the salient portions of which are hereby incorporated by reference within this disclosure.

As fillers, which may likewise be included optionally, it is possible to use not only reinforcing fillers, such as carbon black, for example, but also non-reinforcing fillers, such as carbonates, for example, especially chalk, or sulfates such as barium sulfate, for example. Other examples of fillers that are contemplated are silicates, such as talc, kaolin, calcined or partly calcined kaolin, wollastonites or micas, hydroxides or oxides, such as finely ground quartz, for instance, aluminium hydroxide, zinc oxide or calcium oxide. Microspheres are also contemplated as fillers. Microspheres may be solid glass microspheres, hollow glass microspheres and/or polymeric microspheres of all kinds. The polymeric microspheres may be in preexpanded or unexpanded form. The particle size in the expanded state is usually in the range between 20 and 150 μm. Mixtures of the substances stated may also be used. The types of carbon black contemplated are not subject to any limitation. They include, for example, gas black, furnace black, lamp black, thermal black, acetylene black, all kinds of filler black, pigmentary carbon black, and also conductive carbon black. Colour pigments contemplated include in principle all organic and inorganic kinds.

The thermally curable, meltable adhesive, preferably a pressure-sensitive adhesive, may optionally also comprise tackifier resins. The term “tackifier resin” is to be understood by the skilled person to refer to a resin-based substance which increases the tack. Tackifier resins can be divided into natural resins and synthetic resins. Typical natural resins are rosin-based resins and their derivatives. Rosins include, for example, natural rosin, polymerized rosin, partially hydrogenated rosin, fully hydrogenated rosin, esterified products of these types of rosin (such as glycerol esters, pentaerythritol esters, ethylene glycol esters and methyl esters) and rosin derivates (such as disproportionation rosin, fumaric acid-modified rosin and lime-modified rosin). Typical synthetic resins are polyterpene resins, although the raw materials here come from natural sources; hydrocarbon resins; and terpene-phenolic resins. The polymers in question here are of low molecular weight. The weight-averaged, average molecular weight is generally less than 25 000 g/mol. Polyterpene resins are based on α-pinene and/or ß-pinene and/or δ-limonene. They may be hydrogenated, unhydrogenated or partly hydrogenated. Raw materials for the majority of hydrocarbon resins are by-products obtained in the cracking of naphtha or gas-oil. Hydrocarbon resins may be classified according to whether they are based primarily on aromatic, aliphatic or diene monomers. Aromatics are often referred to as C-9 resins, aliphatics as C-5 resins, and diene resins as (C-5)₂ resins. Mixed aromatic-aliphatic hydrocarbon resins ((C-5/C-9) resins) are likewise included by the concept of the disclosure. Hydrocarbon resins as well may be hydrogenated, unhydrogenated or partly hydrogenated. Further included by the concept of the disclosure are monomer resins of the styrene/α-methylstyrene type (CAS No.: 9011-11-4). Terpene-phenolic resins, according to DIN 16916-1 1981-06 and ISO/TR 8244:1988, are resins produced by acid-catalyzed addition reaction of phenols with terpenes or rosin.

The thermally curable, meltable, preferably pressure-sensitive adhesive may optionally further comprise bitumen. Bitumen is a dark-coloured, high-molecular-mass hydrocarbon mixture which is semi-solid to surprisingly hard and which is obtained as a residue in the distillation of suitable petroleum, further containing chemically bonded sulfur, oxygen, nitrogen and certain traces of metals. In physical terms, bitumen belongs to the thermoplastic substances, meaning that its properties are temperature-dependent. On cooling, it becomes brittle; on heating, it passes steplessly through all of the states from solid via highly viscous to highly mobile. Distinctions are made between, among others, the following bitumen varieties and derived products: roadbuilding bitumen, especially soft bitumen, modified bitumen, especially polymer-modified bitumen, industrial bitumen, especially oxidation bitumen or hard bitumen, flux bitumen and bitumen emulsion.

Preferred for use in the adhesives of the disclosure is roadbuilding bitumen. Particularly preferred is the 50/70 grade, where the numbers indicate the minimum and maximum penetration at 25° C. in the units of mm/10 as per DIN EN 1426. Advantageous concentrations of bitumen in the thermally vulcanizable, meltable adhesive, preferably a pressure-sensitive adhesive, are between 1.0 (inclusive) wt % and from 30.0 (inclusive) wt %. Particularly advantageous are concentrations of between 5.0 (inclusive) wt % and 20.0 (inclusive) wt %. The addition of bitumen allows the oil absorption to be improved when bonding takes place to oiled metal sheets.

The thermally curable, meltable, preferably pressure-sensitive adhesive may optionally further comprise plasticizers. Plasticizers are liquid or solid, inert organic substances of low vapour pressure, primarily of ester-like type, which interact physically with high-polymer substances, without chemical reaction, preferably through their solvency and swelling capacity, and in some cases even without such behaviour, and which are able to form a homogeneous system with said high-polymer substances. The abbreviated designations of plasticizers are regulated in DIN EN ISO 1043-3: 2000-01. The most important plasticizers can be divided into larger groups, which are listed below, with the abbreviated code of DIN EN ISO 1043-3: 2000-01 being given in parentheses.

Phthalic esters, also called phthalates for short, include, among others, dioctyl phthalate (DOP; di(2-ethylhexyl)phthalate), diisononyl phthalate (DINP), diisodecyl phthalate (DIDP), phthalic esters with predominantly linear C₆- to C₁₁ alcohols, dibutyl phthalate (DBP), diisobutyl phthalate (DIBP), dicyclohexyl phthalate (DCHP), dimethyl phthalate (DMP) and diethyl phthalate (DEP), and also mixed esters, comprising benzyl butyl phthalate (BBP), butyl octyl phthalate, butyl decyl phthalate and dipentyl phthalate, bis(2-methoxyethyl) phthalate and dicapryl phthalate (DCP). An example of trimellitic esters with (predominantly) linear C₆- to C₁₁ alcohols is tris(2-ethylhexyl) trimellitate (TOTM). Acyclic aliphatic dicarboxylic esters are, for example, esters of adipic acid such as bis(2-ethylhexyl) adipate (dioctyl adipate, DOA), bis(8-methylnonyl) adipate (diisodecyl adipate, DIDA), dibutyl decanedioate (dibutyl sebacate, DBS), bis(2-ethylhexyl) decanedioate (dioctyl sebacate, DOS). An example of a cyclic aliphatic dicarboxylic ester is diisononyl 1,2-cyclohexanedicarboxylate (DINCH).

Examples of polymer plasticizers are polyesters of adipic, decanedioic, nonanedioic and phthalic acid with diols such as butane-1,3-diol, propane-1,2-diol, butane-1,4-diol, hexane-1,6-diol and others (Mᵣ around 1800-13000 g/mol). Phosphoric esters, called phosphates for short, are a further group. Mention may be made here, by way of example, of tricresyl phosphate (TCF), triphenyl phosphate (TPP), diphenyl cresyl phosphate (DPCF), 2-ethylhexyl diphenyl phosphate (diphenyl octyl phosphate, DPOF), tris(2-ethylhexyl) phosphate (TOF) and tris(2-butoxyethyl) phosphate.

Butyl oleate or butyl stearate are examples of fatty acid esters, which represent a further group. Further examples of this group are methyl esters and butyl esters of acetylated ricinoleic fatty acid and fatty acid glycol esters and also triethylene glycol-bis(2-ethylbutyrate). Citric esters are examples of the group of hydroxycarboxylic esters. Further examples are tartaric esters and lactic esters.

A further group of plasticizers are epoxy plasticizers, for example epoxidized fatty acid derivatives, especially triacylglycerols and monoesters. Certain of the aforementioned epoxy resins as well may be classed within the group of the plasticizers. Mention may further be made of polyamide plasticizers, for example benzenesulfonamides or methylbenzenesulfonamides. Another group of plasticizers are alkylsulfonic esters of phenol (ASE). Mineral oils as well may be considered within the context of the present specification to be plasticizers. Naphthenic mineral oils are preferred. The bitumen as well, already listed separately, could be classed under the heading of the plasticizers.

In one optional embodiment the thermally curable, meltable, preferably pressure-sensitive adhesive comprises further auxiliaries and adjuvants such as, for example, rheological additives, ageing inhibitors (antioxidants), light stabilizers or UV absorbers. Examples of rheological additives are pyrogenic, hydrophobized or non-hydrophobized silicas, phyllosilicates (bentonites), high molecular mass polyamide powders or castor oil derivative powders. The stated rheological additives may also be classed under the heading of fillers. The suitable antioxidants include, for example, sterically hindered phenols, hydroquinone derivates, amines, organic sulfur compounds or organic phosphorus compounds. Light stabilizers used are, for example, the compounds disclosed in Gaechter and Müller, Taschenbuch der Kunststoff-Additive, Munich 1979, in Kirk-Othmer (3rd) 23, 615 to 627, in Encycl. Polym. Sci. Technol. 14, 125 to 148, and in Ullmann (4th) 8, 21; 15, 529, 676, the salient portions of which are hereby incorporated by reference in this disclosure.

The present disclosure further relates to an adhesive tape coated on one side or on both sides at least partially with the adhesive of the disclosure. The adhesive tape here may also be an adhesive transfer tape. An adhesive tape enables particularly simple and precise bonding and is therefore particularly suitable.

The general expression “adhesive tape” encompasses a carrier material which is provided on one or both sides, in each case at least partially, with a (pressure-sensitive) adhesive. Carrier material encompasses all sheetlike structures, examples being two-dimensionally extended films or film sections, tapes with extended length and limited width, tape sections, diecuts (in the form of edge surrounds or borders of an arrangement to be bonded, for example), other shapes, multilayer arrangements, and the like. For different applications it is possible to combine a very wide variety of different carriers, such as, for example, films, woven fabrics, nonwovens and papers, with the adhesives. Furthermore, the expression “adhesive tape” also encompasses what are called “adhesive transfer tapes”, i.e. an adhesive tape without a carrier. In the case of an adhesive transfer tape, the adhesive, prior to the application, is instead applied between flexible liners, which are provided with a release coat and/or which have anti-adhesive properties. For application, generally, first one liner is removed, the adhesive is applied, and then the second liner is removed. The adhesive can thus be used directly to join two surfaces.

Also possible, however, are adhesive tapes which operate not with two liners, but instead with a single liner featuring double-sided release. In that case the web of adhesive tape is lined on its top face with one side of a double-sided releasing liner, while its bottom face is lined with the reverse side of the double-sided releasing liner, more particularly of an adjacent turn on a bale or roll. For certain applications it may be desirable for one side or both sides of the adhesive tape not to be provided completely with adhesive, but instead for partially adhesive-free regions to be provided, in order to take account, for example, of cutouts in the surfaces to which bonding is to take place.

As the carrier material of an adhesive tape it is presently preferred to use polymer films, film composites, or films or film composites provided with organic and/or inorganic layers; films, especially dimensionally stable polymeric films or metal foils, are preferred. Such films/film composites may consist of any common plastics used in film production, with examples, although without description, including the following: polyethylene, polypropylene—especially the oriented polypropylene (OPP) produced by monoaxial or biaxial stretching, cyclic olefin copolymers (COC), polyvinyl chloride (PVC), polyesters—especially polyethylene terephthalate (PET) and poylethylene naphthalate (PEN), ethylene-vinyl alcohol (EVOH), polyvinylidene chloride (PVDC), polyvinylidene fluoride (PVDF), polyacrylonitrile (PAN), polycarbonate (PC), polyamide (PA), polyethersulfone (PES) or polyimide (PI). Polyester films have the advantage that they ensure temperature stability and provide enhanced mechanical stability. With very particular preference, therefore, a carrier layer in a liner of the disclosure consists of a polyester film, for example of biaxially oriented polyethylene terephthalate.

In the case of double-sided (self-)adhesive tapes, the adhesives of the disclosure used as the top and bottom layers may be identically different in nature and/or may be used in identical or different thicknesses. The carrier in this case may have been pretreated according to prior art on one or both sides, to achieve, for example an improvement in adhesive anchorage. The layers of PSA may optionally be lined with release papers or release films. Alternatively it is also possible for only one layer of adhesive to be lined with a double-sided releasing liner. In one variant, an adhesive of the disclosure is provided in the double-sided (self-)adhesive tape, and an arbitrary further adhesive, for example one which adheres particularly well to a masking substrate or which exhibits particularly good repositionability.

The thickness of the layer of adhesive, present either as adhesive transfer tape or coated on a sheetlike structure, is preferably between 10 μm and 5000 μm, more preferably between 100 μm and 4000 μm and very preferably between about 200 μm and 3000 μm. For double-sided adhesive tapes it is likewise the case for the adhesives that the thickness of the individual layer or layers of PSA is preferably between 10 μm and 5000 μm, more preferably between 100 μm and 4000 μm, and very preferably between about 200 μm and 3000 μm.

Adhesive tapes coated on one or both sides with adhesives usually end their production process by being wound up into a roll in the form of an Archimedean spiral or in cross-wound form. To prevent the adhesives making contact with one another in the case of double-sided adhesive tapes, or to prevent the adhesives sticking to the carrier in the case of single-sided adhesive tapes, the tapes prior to winding are lined with a covering material (also referred to as release material) which is wound up together with the adhesive tape. Names given by the skilled person to such covering materials are liners or release liners. In addition to the covering of single-sided or double-sided adhesive tapes, liners are also used for the lining of pure adhesives (adhesive transfer tape) and adhesive-tape sections (labels for example).

The thermally curable, meltable, preferably pressure-sensitive adhesive of the present disclosure is used preferably as a layer for producing a thermally curable, preferably pressure-sensitive adhesive tape or sealing tape, and also shaped articles or diecuts produced therefrom, and the thermally curable, meltable, preferably pressure-sensitive adhesive tape or sealing tape here may comprise additional pressure-sensitive adhesive and/or non-pressure-sensitive adhesive layers, carrier films or foils, adhesion-promoting layers, release layers or other functional layers, and also a plurality of adhesive-tape layers which can be cured thermally or can be otherwise cured or crosslinked, and it may have been furnished with a release liner, which may have siliconization on one or both sides.

A thermally curable, meltable, preferably pressure-sensitive adhesive tape layer is produced preferably in a solvent-free, continuous compounding and coating process. The metered addition of the ground reaction product of phthalic anhydride and diethylenetriamine and of the other, optional, known formulating constituents, for example fillers, carbon black, colour pigments, microspheres, rheological additives, plasticizers, tackifier resins, bitumen, ageing inhibitors, light stabilizers, UV absorbers and also other auxiliaries and adjuvants, is made preferably into the continuously operating mixing assembly, more particularly the compounding extruder, during the continuous compounding process.

The thermally curable, meltable, preferably pressure-sensitive adhesive of the disclosure and also pressure-sensitive adhesive tapes produced from it exhibit an outstanding combination of product properties, of a kind which could not have been predicted even by the skilled person. The adhesive of the disclosure and the adhesive tape produced from it surprisingly cure to a high strength even at a temperature of 110° C. in approximately 15 to 20 minutes. At 180° C. the cure time is approximately 5 minutes. In the lap shear test based on DIN EN 1465, lap shear strengths of approximately 10 to 25 MPa are achieved, depending on factors including the curing temperature, the cure time, and precise formulation of the adhesive. Adhesion to cathodically electrocoated sheets is very good; cohesive fracture modes are consistently obtained. The adhesion to oiled sheets may be adjusted, using the optional formulating constituents, in such a way as to be likewise very good, and so cohesive fracture modes are obtained here as well. Owing to the use of epoxide-functionalized acrylonitrile/butadiene copolymers, there is, as expected, no brittle fracture, in other words no flaking of the adhesive or of the adhesive tape produced from it from the substrate. The adhesive of the disclosure and the adhesive tape produced from it are, surprisingly, unusually storage-stable. At a storage temperature of 60° C., the adhesive and the adhesive tape produced from it are stable for approximately one month, meaning that they can be used without limitations. At a storage temperature of 23° C., storage stability is more than one year.

The aforementioned substrates to which the adhesive or the adhesive tape produced from it is applied may typically be oiled steel sheets of the kind used in bodyshell construction in the automotive industry. These sheets may be galvanized or ungalvanized. Other types of metal as well, such as aluminium, for example, are suitable. Alternatively, the substrates may be painted or precoated metal sheets, examples being cataphoretically dip-painted sheets (cathodically electrocoated sheets), of the kind present on the painting lines in the automotive industry.

On the basis of the low curing temperature, there are also numerous plastics which can be bonded using this adhesive and/or the adhesive tape produced from it. Examples of suitable plastics substrates are acrylonitrile-butadiene-styrene copolymers (ABS), polycarbonates (PC), ABS/PC blends, PMMA, polyamides, glass fibre-reinforced polyamides, polyvinyl chloride, styrene acrylonitrile copolymers, polyacrylates and polymethacrylates, polyoxymethylene, acrylate-styrene-acrylonitrile copolymers, polystyrene, and/or polyesters, such as polybutylene terephthalates (PBT) and/or polyethylene terephthalate (PET), for example. The substrates may have been painted, printed, vapour-coated or sputter-coated.

Using the optional formulating constituents, the adhesive of the disclosure and the adhesive tape produced from it may be formulated in such a way that they can be used both for bonding and for sealing, for example for hem fold bonding, for hem fold sealing, for seam sealing, for underseal bonding, for hole stopping, and much more. The adhesive of the disclosure and the adhesive tape produced from it are pressure-sensitive adhesive. The pressure-sensitive tack may be boosted or attenuated with the optional formulating constituents. This may be done, for example, via the fraction of fillers or tackifier resins, to name just two possibilities.

An adhesive tape layer composed of the thermally curable, meltable, preferably pressure-sensitive adhesive of the disclosure can be produced in a solvent-free, continuous or else discontinuous compounding and extrusion process without any curing in such a hotmelt production process. The process temperatures in this case range between 40° C. and 60° C., according to the viscosity of the adhesive of the disclosure. Through the possibility of producing the adhesive tape layer from the adhesive of the disclosure in a hotmelt process, it is possible advantageously to produce very thick layers, several millimetres thick, for example, without any disruptive blistering. Since the adhesive of the disclosure, before curing, passes briefly through a liquid state of high viscosity, it is possible to achieve gap-filling properties.

At room temperature up to approximately 30° C., the adhesive of the disclosure is sufficiently solid or of high viscosity to allow it to be wound to a roll in the form of a film coated onto a release liner or onto a carrier material, without running out of the side or being squeezed out as a result of the winding pressure. The adhesive and the adhesive tape produced from it prove respectively to be very storage-stable. They do not require cooled storage, which is a great advantage. The storage stability extends to a period of more than one year at room temperature. Even at 60° C., the storage stability is approximately one month. The storage stability is determined, after the specified storage time and storage temperature, by using the adhesive or the adhesive tape produced from it for bonding again, and comparing the measured lap shear strength with the lap shear strength in the fresh state. No significant differences were found.

The intention of the examples below is to describe the disclosure in more detail, without thereby wishing to limit the disclosure.

### EXAMPLES

Test Methods

The following test methods were used to provide brief characterization of the specimens of the disclosure.

Dynamic Shear Test (Lap Shear Strength)

The dynamic shear test took place on the basis of DIN EN 1465. It always took place after the thermal curing of the bonded samples. For this purpose, rectangular diecuts with dimensions of 25.0 mm×12.5 mm were punched from an adhesive tape layer comprising the adhesive of the disclosure lined on both sides with one release paper in each case. The release papers were subsequently removed in each case from one side of a diecut. The thickness of the diecuts was always between 0.4 and 0.6 mm (0.5±0.1 mm).

The diecuts were placed congruently in each case onto the end of a test specimen (substrate) with dimensions of 100.0 mm×25.0 mm×2.0 mm. The diecuts now adhered in each case to this test specimen. Test specimens of cataphoretically dip-painted steel (CDP steel), steel, electrogalvanized steel and hot dip-galvanized steel were used. The designations of the test specimens were as follows: (a) “Cataphoretically dip-painted steel (CDP steel)”: DC04 steel test specimens, trimmed and then coated with Daimler OEM KTL Kathoguard 800; b) “Steel”: DC04; c) “Electrogalvanized steel”: DC01ZE 25/25; and d) “Hot dip-galvanized steel”: DX51 D+Z275. The supplier of all of the stated test specimens was Rocholl GmbH.

Before the diecuts were applied, the unpainted test specimens were partly oiled (see results tables). The designation of the oil was Anticorit RP 4107 S (from Fuchs) and it was applied in a thickness of 2 to 3 g/m². Thereafter the release papers still remaining on the diecuts were removed.

Next, test specimens made of the same material in each case were placed in each case flush with one end in such a way as to result in each case in an overlapping assembly as described in DIN EN 1465. The length of overlap was 12.5 mm in each case. The area of overlap was 312.5 mm² in each case. The overlapping assemblies were placed onto a metal sheet, with shims ensuring that the upper test specimen was unable to tip. A weight of 2 kg was placed on the upper test specimen in the region of the overlap area in each case. The assembly was subjected to the pressure of the weight for 10 seconds in each case at room temperature (pressing time). The weight was then removed. The assembly was subsequently exposed for 5 to 30 minutes to a temperature between 110° C. to 230° C. During this exposure there was a curing reaction within the adhesive tape layer samples, and a strong adhesion developed between the respective adhesive tape layer samples and the respective test specimens. Adhesive bonding therefore took place, with a considerable increase in strength. The lap shear strength was determined after cooling and after a waiting time of two to three hours.

Determining the lap shear strength of overlap bonds provides information on the extent to which a double-sided adhesive product can be subjected to shearing loads. The determination was made according to DIN EN 1465 by means of a tensile testing machine. The test velocity was 10 mm/min. All measurements were carried out in a conditioned chamber at 23° C. and 50% relative humidity.

Experimental Section

The following methods were used to make the adhesives and adhesive tapes of the examples in the disclosure.

Production of the Adhesive of the Disclosure and the Adhesive Tape Layer of the Disclosure

The adhesive of the examples was manufactured in laboratory batches in a heatable and evacuatable 1 litre planetary mixer from PC-Laborsystem. For this, the epoxide-functionalized acrylonitrile/butadiene copolymer was first preheated to 60° C. and then weighed out into the mixing canister, together with the ground reaction product of phthalic anhydride and diethylenetriamine and, where used, with the further, optional formulating constituents, with subsequent mixing for two hours at a temperature of 40° C. to 60° C. In the second hour, reduced pressure was applied in order to free the mixture from residual moisture. Thereafter a film in the desired thickness was produced from the mixture in each case, by pressing the mixture between two steel plates, lined with siliconized polyester films, at 60° C. After this shaping operation, the film was cooled to room temperature, causing it to solidify. The film thus produced is the adhesive tape layer of the disclosure.

Some of the adhesives of the examples were alternatively manufactured in a compounding extruder.

For this, the epoxide-functionalized acrylonitrile/butadiene copolymer was pumped by means of a drum melt pump at 60° C. into a twin-screw extruder from Krauss Maffei Berstorff with the extruder designation ZE30Rx54D UTXmi. The extruder was heated electrically from the outside to around 40° C. to 60° C. and was air-cooled via a variety of fans. It was designed so as to ensure effective commixing of the epoxide-functionalized acrylonitrile/butadiene copolymer and the further substances, such as, in particular, the ground reaction product of phthalic anhydride and diethylenetriamine, the fillers, and also the further auxiliaries and adjuvants, in the extruder within a short residence time. For this purpose, the mixing screws of the twin-screw extruder were arranged in such a way that conveying elements alternated with mixing elements. The further substances were added with suitable metering equipment, using metering aids, into the unpressurized conveying zones of the twin-screw extruder. Alternatively to the twin-screw extruder, it is advantageously also possible to use a planetary roller extruder or an annular extruder, since this allows the compounding temperatures to be held more easily below 60° C. Advantageous extruders also enable the degassing of the compound.

After emergence of the mixture, at a temperature of around 60° C., from the twin-screw extruder (exit: circular die 5 mm in diameter), it was shaped to form a film directly by means of a downstream two-roll applicator, between two incoming, double-sided siliconized polyester films 50 μm thick. The feed rate was varied between 1 m/min and 20 m/min. One of the incoming, double-sided siliconized polyester films was removed again immediately after the film had cooled and therefore solidified. The film present was subsequently ground up onto a cylindrical core. This film is the adhesive tape layer of the disclosure.

Table 1 lists the base materials (raw materials) used in the production of the adhesives and the adhesive tape layers of the examples, in each case with trade name, manufacturer and the technical data relevant to this disclosure.

TABLE 1
Base materials (raw materials) used in producing the
adhesive of the disclosure

| | | Epoxide | NH | |
|---|---|---|---|---|
| | | equi- | equi- | |
| | | valent | valent | Manu- |
| | | weight | weight | facturer/ |
| Tradename | Description | (g/eq) | (g/eq) | Supplier |
| Struktol ® | Chain-extended | 600 | | Schill + |
| Polydis | acrylonitrile/butadiene | | | Seilacher |
| 3610 | copolymer (CTBN base)*, | | | |
| | epoxide-terminated with | | | |
| | bisphenol A diglycidyl | | | |
| | ether resin | | | |
| Struktol ® | Chain-extended | 550 | | Schill + |
| Polydis 3611 | acrylonitrile/butadiene | | | Seilacher |
| | copolymer (CTBN base)*, | | | |
| | epoxide-terminated with | | | |
| | bisphenol F diglycidyl | | | |
| | ether resin | | | |
| Aradur ® | Ground reaction product of | | 77.7 | Huntsman |
| 9506 | phthalic anhydride and | | | |
| | diethylenetriamine, | | | |
| | CAS number: 68003-28-1 | | | |
| Talkum | Talc, CAS No.: 14807-96- | | | Scheruhn |
| Pharma | 6, spec. surface area: | | | GmbH |
| M ® | 4.6 m²/g | | | |
| Omyacarb ® | Ground chalk, mean | | | Omya |
| 5-GU | particle diameter: 5.5 μm | | | |

*CTBN = Carboxyl-terminated copolymers of acrylonitrile and butadiene

### Example 1

The composition of the adhesive of this example is listed in Table 2. Production took place in a laboratory batch (1 litre) and in an extrusion process.

TABLE 2
Composition of Example 1

| | | Number of epoxide | | Ratio of the number of |
|---|---|---|---|---|
| | | and/or NH groups | | epoxide groups to the |
| | Weight | introduced, based | | number of NH groups, |
| Raw | fraction | on the percentage | | standardized to 1.00 |
| material | [wt %] | weight fraction | | mmol epoxide groups |
| Struktol ® | 91.4 | 152.3 | mmol epoxide | 1.00 |
| Polydis 3610 | | | | |
| Aradur ® 9506 | 8.6 | 110.7 | mmol NH | 0.73 |

| | |
|---|---|
| Total | 100.00 |

Lap shear strength results for this example are provided in Table 3. The fracture modes listed in Table 3 are: A=adhesive, MF=mixed fracture, and C=cohesive (no brittle fracture). The storage stability was longer than one month at 60° C. and longer than one year at 23° C. The adhesive is a pressure-sensitive adhesive prior to curing.

TABLE 3
Lap shear strengths of Example 1 [MPa]

| | Substrate | CDP | | | | | |
|---|---|---|---|---|---|---|---|
| | Curing temperature | 110° C. | | 130° C. | | 160° C. | |
| Cure | 5 minutes | 2.1 | (A) | 5.9 | (A) | 17.9 | (MF) |
| time | 15 minutes | 10.7 | (MF) | 16.3 | (MF) | 20.8 | (C) |
| | 30 minutes | 13.4 | (C) | 20.2 | (C) | 22.6 | (C) |

### Example 2

The composition of the adhesive of this example is listed in Table 4. Production took place in a laboratory batch (1 litre) and in an extrusion process.

TABLE 4
Composition of Example 2

| | | | | Ratio of the number of |
|---|---|---|---|---|
| | | Number of epoxide | | epoxide groups to the |
| | | and/or NH groups | | number of NH groups, |
| | Weight | introduced, based on | | standardized to |
| | fraction | the percentage weight | | 1.00 mmol epoxide |
| Raw material | [wt %] | fraction | | groups |
| Struktol ® | 95.5 | 159.2 | mmol epoxide | 1.00 |
| Polydis 3610 | | | | |
| Aradur ® 9506 | 4.5 | 57.9 | mmol NH | 0.36 |

| | |
|---|---|
| Total | 100.00 |

Lap shear strength results for this example are provided in Table 5. The fracture modes listed in Table 5 are: A=adhesive, MF=mixed fracture, and C=cohesive (no brittle fracture). The storage stability was longer than one month at 60° C. and longer than one year at 23° C. The adhesive is a pressure-sensitive adhesive prior to curing.

TABLE 5
Lap shear strengths of Example 2 [MPa]

| | Substrate | CDP | | | | | |
|---|---|---|---|---|---|---|---|
| | Curing temperature | 110° C. | | 130° C. | | 160° C. | |
| Cure time | 5 minutes | 1.2 | (A) | 3.6 | (A) | 10.5 | (MF) |
| | 15 minutes | 3.1 | (MF) | 6.0 | (C) | 12.2 | (C) |
| | 30 minutes | 5.0 | (MF) | 8.9 | (C) | 13.6 | (C) |

### Example 3

The composition of the adhesive of this example is listed in Table 6. Production took place in a laboratory batch (1 litre) and in an extrusion process.

TABLE 6
Composition of Example 3

| | | | | Ratio of the number |
|---|---|---|---|---|
| | | Number of epoxide | | of epoxide groups to |
| | | and/or NH groups | | the number of NH |
| | Weight | introduced, based | | groups, standardized |
| Raw | fraction | on the percentage | | to 1.00 mmol |
| material | [wt %] | weight fraction | | epoxide groups |
| Struktol ® | 73.1 | 121.8 | mmol epoxide | 1.00 |
| Polydis 3610 | | | | |
| Aradur ® 9506 | 6.9 | 88.8 | mmol NH | 0.73 |

| | |
|---|---|
| Talkum | 20.0 |
| Pharma M ® | |
| Total | 100.00 |

Lap shear strength results for this example are provided in Tables 7 and 8. The fracture modes listed in Tables 7 and 8 are: A=adhesive, MF=mixed fracture, and C=cohesive (no brittle fracture). The storage stability was longer than one month at 60° C. and longer than one year at 23° C. The adhesive is a pressure-sensitive adhesive prior to curing.

TABLE 7
Lap shear strengths of Example 3 [MPa]

| | Substrate | CDP | | | | | |
|---|---|---|---|---|---|---|---|
| | Curing temperature | 110° C. | | 130° C. | | 160° C. | |
| Cure time | 5 minutes | 1.9 | (A) | 6.4 | (C) | 8.7 | (C) |
| | 15 minutes | 4.5 | (MF) | 8.9 | (C) | 11.4 | (C) |
| | 30 minutes | 10.2 | (C) | 11.0 | (C) | 12.2 | (C) |

TABLE 8
Lap shear strengths of Example 3 [MPa]

| | Curing temperature/Cure time | | | | | |
|---|---|---|---|---|---|---|
| | 180° C./30 minutes | | | | | |
| | | | | Electro- | | Hot dip- |
| | | | Electro- | galvanized | Hot dip- | galvanized |
| | | Steel, | galvanized | steel, | galvanized | steel, |
| Substrate | Steel | oiled | steel | oiled | steel | oiled |
| Lap shear strength | 11.6 (C) | 12.9 (C) | 14.7 (C) | 10.6 (MF) | 15.3 (C) | 12.3 (MF) |
| [MPa] | | | | | | |

### Example 4

The composition of the adhesive of this example is listed in Table 9. Production took place in a laboratory batch (1 litre).

TABLE 9
Composition of Example 4

| | | | | Ratio of the number |
|---|---|---|---|---|
| | | Number of epoxide | | of epoxide groups to |
| | | and/or NH groups | | the number of NH |
| | Weight | introduced, based | | groups, standardized |
| Raw | fraction | on the percentage | | to 1.00 mmol |
| material | [wt %] | weight fraction | | epoxide groups |
| Struktol ® | 54.9 | 91.5 | mmol epoxide | 1.00 |
| Polydis 3610 | | | | |
| Aradur ® 9506 | 5.1 | 65.6 | mmol NH | 0.72 |

| | |
|---|---|
| Talkum Pharma | 20.0 |
| M ® | |
| Omyacarb ® | 20.0 |
| 5-GU | |
| Total | 100.00 |

Lap shear strength results for this example are provided in Tables 10 and 11. The fracture modes listed in Tables 10 and 11 are: A=adhesive, MF=mixed fracture, and C=cohesive (no brittle fracture). The storage stability was longer than one month at 60° C. and longer than one year at 23° C. The adhesive is a pressure-sensitive adhesive prior to curing.

TABLE 10
Lap shear strengths of Example 4 [MPa]

| | Substrate | | | | | | |
|---|---|---|---|---|---|---|---|
| | Curing | CDP | | | | | |
| | temperature | 110° C. | | 130° C. | | 160° C. | |
| Cure time | 5 minutes | 1.3 | (A) | 3.5 | (A) | 8.1 | (MF) |
| | 15 minutes | 5.9 | (C) | 7.0 | (MF) | 11.9 | (C) |
| | 30 minutes | 8.2 | (C) | 10.7 | (C) | 13.8 | (C) |

TABLE 11
Lap shear strengths of Example 4 [MPa]

| | Curing temperature/Cure time | | | | | |
|---|---|---|---|---|---|---|
| | 180° C./30 minutes | | | | | |
| | | | | Electro- | | Hot dip- |
| | | | Electro- | galvanized | Hot dip- | galvanized |
| | | Steel, | galvanized | steel, | galvanized | steel, |
| Substrate | Steel | oiled | steel | oiled | steel | oiled |
| Lap shear strength | 13.0 (C) | 9.5 (A) | 13.1 (MF) | 7.7 (A) | 13.5 (C) | 8.5 (MF) |
| [MPa] | | | | | | |

### Example 5

The composition of the adhesive of this example is listed in Table 12. Production took place in a laboratory batch (1 litre).

TABLE 12
Composition of Example 5

| | | | | Ratio of the number |
|---|---|---|---|---|
| | | Number of epoxide | | of epoxide groups to |
| | | and/or NH groups | | the number of NH |
| | Weight | introduced, based | | groups, standardized |
| Raw | fraction | on the percentage | | to 1.00 mmol |
| material | [wt %] | weight fraction | | epoxide groups |
| Struktol ® | 90.7 | 164.9 | mmol epoxide | 1.00 |
| Polydis 3611 | | | | |
| Aradur ® 9506 | 9.3 | 119.7 | mmol NH | 0.73 |

| | |
|---|---|
| Total | 100.00 |

Lap shear strength results for this example are provided in Table 13. The fracture modes listed in Table 13 are: A=adhesive, MF=mixed fracture, and C=cohesive (no brittle fracture). The storage stability was longer than one month at 60° C. and longer than one year at 23° C. The adhesive is pressure-sensitive adhesive prior to curing.

TABLE 13
Lap shear strengths of Example 5 [MPa]

| | Substrate | CDP | | | | | |
|---|---|---|---|---|---|---|---|
| | Curing temperature | 110° C. | | 130° C. | | 160 °C. | |
| Cure time | 5 minutes | 1.9 | (A) | 3.8 | (A) | 15.2 | (MF) |
| | 15 minutes | 7.2 | (MF) | 13.0 | (C) | 16.9 | (C) |
| | 30 minutes | 9.4 | (C) | 14.1 | (C) | 17.4 | (C) |

According to a first aspect of the disclosure, an adhesive is provided. The adhesive comprises: an epoxide-functionalized acrylonitrile/butadiene copolymer having on average more than 1.5 epoxide groups per molecule; and a reaction product of phthalic anhydride and diethylenetriamine. The reaction product is in ground form. Further, the adhesive is meltable and thermally curable.

According to a second aspect, the first aspect is provided, wherein the adhesive is meltable between 40° C. and 60° C.

According to a third aspect, the second aspect is provided, wherein the adhesive is thermally curable between 110° C. and 230° C.

According to a fourth aspect, the third aspect is provided, wherein the adhesive is further characterized by a viscosity from about 20° C. to about 30° C. of at least 1000 Pa·s.

According to a fifth aspect, the third aspect is provided, wherein the adhesive is further characterized by a viscosity from about 20° C. to about 30° C. of at least 3000 Pa·s.

According to a sixth aspect, the fourth aspect is provided, wherein the adhesive is a pressure sensitive adhesive comprising each of a storage modulus (G′) and a loss modulus (G″) at least partly within a range from 103 to 107 Pa at room temperature.

According to a seventh aspect, the first aspect is provided, wherein the epoxide-functionalized acrylonitrile/butadiene copolymer is the product of a chemical reaction of a carboxyl-terminated acrylonitrile/butadiene copolymer with (a) a bisphenol A diglycidyl ether, a bisphenol F diglycidyl ether or an epichlorohydrin, and/or (b) a bisphenol A diglycidyl ether or a bisphenol F diglycidyl ether chain-extended by a chemical reaction with bisphenol A or bisphenol F.

According to an eighth aspect, the first aspect is provided, wherein the reaction product of phthalic anhydride and diethylenetriamine further comprises a free diethylenetriamine content between 1.0 and 5.0 wt. %.

According to a ninth aspect, the eighth aspect is provided, wherein the reaction product is in ground form such that at least 95 wt. % of the reaction product has a particle size of less than or equal to 70 μm as measured according to the ISO 13320:2009 standard entitled “Particle size analysis—Laser diffraction methods”.

According to a tenth aspect, the ninth aspect is provided, comprising one or more fillers selected from the group consisting of carbon black, cabonates, sulfates, silicates, hydroxides, oxides, colour pigments, microspheres, rheological additives, plasticizers, tackifier resins, bitumen, ageing inhibitors, light stabilizers, and UV absorbers.

According to an eleventh aspect, the tenth aspect is provided, wherein the epoxide-functionalized acrylonitrile/butadiene copolymer is from 50 wt. % to 98 wt. %, the reaction product is from 2 wt. % to 10 wt. %, and the one or more fillers is from 15 wt. % to 45 wt. % of the total weight of the adhesive.

According to a twelfth aspect, the first aspect is provided, wherein the adhesive further comprises a lap shear strength from about 10 MPa to about 25 MPa, as measured according to the DIN EN 1465 standard on a cataphoretic dip-painted steel (CDP) substrate.

According to a thirteenth aspect, the eleventh aspect is provided, wherein the epoxide-functionalized acrylonitrile/butadiene copolymer is from 50 wt. % to 98 wt. % and the reaction product is from 2 wt. % to 10 wt. % of the total weight of the adhesive.

According to a fourteenth aspect, an adhesive is provided. The adhesive comprises: an epoxide-functionalized acrylonitrile/butadiene copolymer having on average more than 1.5 epoxide groups per molecule; and a reaction product of phthalic anhydride and diethylenetriamine. The reaction product is in ground form. The adhesive is meltable between 40° C. and 60° C. and thermally curable between 110° C. and 230° C. Further, a ratio of the number of NH bonds in the reaction product of phthalic anhydride and diethylenetriamine to the total number of epoxide groups is between 0.1 and 1.5, as determined by using a theoretical equivalent weight of 77.7 g per mol of the NH bonds.

According to a fifteenth aspect, the fourteenth aspect is provided, wherein the ratio of the number of NH bonds in the reaction product of phthalic anhydride and diethylenetriamine to the total number of epoxide groups is between 0.1 and 1.5, as determined by using a theoretical equivalent weight of 77.7 g per mol of the NH bonds.

According to a sixteenth aspect, the fourteenth aspect is provided, wherein the ratio of the number of NH bonds in the reaction product of phthalic anhydride and diethylenetriamine to the total number of epoxide groups is between 0.5 and 0.9, as determined by using a theoretical equivalent weight of 77.7 g per mol of the NH bonds.

According to a seventeenth aspect, the fourteenth aspect is provided, wherein the epoxide-functionalized acrylonitrile/butadiene copolymer is the product of a chemical reaction of a carboxyl-terminated acrylonitrile/butadiene copolymer with (a) a bisphenol A diglycidyl ether, a bisphenol F diglycidyl ether or an epichlorohydrin, and/or (b) a bisphenol A diglycidyl ether or a bisphenol F diglycidyl ether chain-extended by a chemical reaction with bisphenol A or bisphenol F.

According to an eighteenth aspect, the fourteenth aspect is provided, wherein the adhesive further comprises a lap shear strength from about 10 MPa to about 25 MPa, as measured according to the DIN EN 1465 standard on a cataphoretic dip-painted steel (CDP) substrate.

According to a nineteenth aspect, the eighteenth aspect is provided, wherein the epoxide-functionalized acrylonitrile/butadiene copolymer is from 50 wt. % to 98 wt. % and the reaction product is from 2 wt. % to 10 wt. % of the total weight of the adhesive.

According to a twentieth aspect, an adhesive tape is provided. The adhesive comprises: at least one carrier layer, the carrier layer comprising a woven fabric, a nonwoven, a paper or a film; and the adhesive according to the fourteenth aspect. Further, the adhesive is disposed on the at least one carrier layer.

According to a twenty-first aspect of the disclosure, an adhesive is provided. The adhesive comprises an epoxide-functionalized acrylonitrile/butadiene copolymer having on average more than 1.5 epoxide groups per molecule, and the ground reaction product of phthalic anhydride and diethylenetriamine.

According to a twenty-second aspect, the twenty-first aspect is provided, wherein the adhesive is meltable.

According to a twenty-third aspect, one of the twenty-first or twenty-second aspects is provided, wherein the adhesive is thermally curable.

According to a twenty-fourth aspect, any one of the twenty-first through twenty-third aspects is provided, wherein the adhesive is pressure-sensitive adhesive.

According to a twenty-fifth aspect, any one of the twenty-first through twenty-fourth aspects is provided, wherein the epoxide-functionalized acrylonitrile/butadiene copolymer is the product of chemical reaction of a carboxyl-terminated acrylonitrile/butadiene copolymer with a bisphenol A diglycidyl ether or a bisphenol F diglycidyl ether or epichlorohydrin and/or with a bisphenol A diglycidyl ether or bisphenol F diglycidyl ether chain-extended by chemical reaction with bisphenol A or bisphenol F.

According to a twenty-sixth aspect, any one of the twenty-first through twenty-fifth aspects is provided, wherein the ground reaction product of phthalic anhydride and diethylenetriamine has a free diethylenetriamine content between 1.0 and 5.0 wt. % inclusive and/or to an extent of at least 95 wt. % has a particle size of less than or equal to 70 μm (laser light scattering; ISO 13320:2009).

According to a twenty-seventh aspect, any one of the twenty-first through twenty-sixth aspects is provided, wherein the ratio of the number of NH bonds in the ground reaction product of phthalic anhydride and diethylenetriamine to the total number of epoxide groups is between 0.1 and 1.5 inclusive, preferably between 0.3 and 1.2 inclusive, more preferably between 0.5 and 0.9, the basis for the calculation for the reaction product of phthalic anhydride and diethylenetriamine being a theoretical equivalent weight of 77.7 g per mol of NH bonds.

According to a twenty-eighth aspect, any one of the twenty-first through twenty-seventh aspects is provided, wherein the ground reaction product of phthalic anhydride and diethylenetriamine in terms of amount of substance relative to dicyandiamide is the preponderant latent curing agent of the adhesive, preferably having an amount-of-substance fraction of at least 90% relative to dicyandiamide, more preferably an amount-of-substance fraction of 100%.

According to a twenty-ninth aspect, any one of the twenty-first through twenty-eight aspects is provided, wherein the epoxide-functionalized acrylonitrile/butadiene copolymer having on average more than 1.5 epoxide groups per molecule in terms of amount of substance relative to bisphenol A diglycidyl ether or bisphenol F diglycidyl ether or a diglycidyl ether chain-extended with bisphenol A or bisphenol F is the preponderant epoxide-group-carrying substance of the adhesive, preferably having an amount-of-substance fraction of at least 90% relative to bisphenol A diglycidyl ether or bisphenol F diglycidyl ether or a diglycidyl ether chain-extended with bisphenol A or bisphenol F, more preferably an amount-of-substance fraction of 100%.

According to a thirtieth aspect, any one of the twenty-first through twenty-ninth aspects is provided, wherein there is no chemically blocked, amine-reactive reaction component in the adhesive.

According to a thirty-first aspect, any one of the twenty-first through thirtieth aspects is provided, wherein the adhesive comprises further, optional, known formulating constituents, such as, for example, fillers, carbon black, colour pigments, microspheres, rheological additives, plasticizers, tackifier resins, bitumen, ageing inhibitors, light stabilizers, UV absorbers, and also other auxiliaries and adjuvants.

According to a thirty-second aspect, any one of the twenty-first through thirty-first aspects is provided, wherein a method for producing the thermally curable adhesive comprises the mixing of the substances, wherein that during the mixing process the temperature of the mixture at no time exceeds 60° C. and in that the mixing, at least towards the end of the mixing process, takes place under reduced pressure.

According to a thirty-third aspect, an adhesive tape is provided. The adhesive tape comprises: at least one layer of a thermally curable adhesive according to any one of the twenty-first through thirty-first aspects, or obtainable according to the twenty-second aspect.

According to a thirty-fourth aspect, the thirty-third aspect is provided, comprising at least one layer of a carrier material, more particularly a layer of woven fabric, nonwoven, paper or film.

According to a thirty-fifth aspect, one of the twenty-third or twenty-fourth aspects is provided, wherein production takes places in a solvent-free, continuous compounding and coating process, more particularly by metered addition of the ground reaction product of phthalic anhydride and diethylenetriamine, of the fillers, carbon black, colour pigments, microspheres, rheological additives, plasticizers, tackifier resins, bitumen, ageing inhibitors, light stabilizers, UV absorbers, and also the other auxiliaries and adjuvants into the continuously operating assembly, more particularly the compounding extruder, during the continuous compounding process.

While exemplary embodiments and examples have been set forth for illustrative purposes, the foregoing description is not intended in any way to limit the scope of the disclosure and the appended claims. Accordingly, variations can be made to the embodiments and examples above without departing from the principles of the disclosure.

What is claimed is:

1. An adhesive, comprising:
an epoxide-functionalized acrylonitrile/butadiene copolymer having on average more than 1.5 epoxide groups per molecule; and
a reaction product of phthalic anhydride and diethylenetriamine,
wherein the reaction product is in ground form, and
further wherein the adhesive is meltable and thermally curable.

2. The adhesive according to claim 1, wherein the adhesive is meltable between 40° C. and 60° C.

3. The adhesive according to claim 2, wherein the adhesive is thermally curable between 110° C. and 230° C.

4. The adhesive according to claim 3, wherein the adhesive is further characterized by a viscosity from about 20° C. to about 30° C. of at least 1000 Pa·s.

5. The adhesive according to claim 3, wherein the adhesive is further characterized by a viscosity from about 20° C. to about 30° C. of at least 3000 Pa·s.

6. The adhesive according to claim 4, wherein the adhesive is a pressure sensitive adhesive comprising each of a storage modulus (G′) and a loss modulus (G″) at least partly within a range from 10³ to 10⁷ Pa at room temperature.

7. The adhesive according to claim 1, wherein the epoxide-functionalized acrylonitrile/butadiene copolymer is the product of a chemical reaction of a carboxyl-terminated acrylonitrile/butadiene copolymer with (a) a bisphenol A diglycidyl ether, a bisphenol F diglycidyl ether or an epichlorohydrin, and/or (b) a bisphenol A diglycidyl ether or a bisphenol F diglycidyl ether chain-extended by a chemical reaction with bisphenol A or bisphenol F.

8. The adhesive according claim 1, wherein the reaction product of phthalic anhydride and diethylenetriamine further comprises a free diethylenetriamine content between 1.0 and 5.0 wt. %.

9. The adhesive according to claim 8, wherein the reaction product is in ground form such that at least 95 wt. % of the reaction product has a particle size of less than or equal to 70 μm as measured according to the ISO 13320:2009 standard entitled “Particle size analysis—Laser diffraction methods”.

10. The adhesive according to claim 9, further comprising one or more fillers selected from the group consisting of carbon black, cabonates, sulfates, silicates, hydroxides, oxides, colour pigments, microspheres, rheological additives, plasticizers, tackifier resins, bitumen, ageing inhibitors, light stabilizers, and UV absorbers.

11. The adhesive according to claim 10, wherein the epoxide-functionalized acrylonitrile/butadiene copolymer is from 50 wt. % to 98 wt. %, the reaction product is from 2 wt. % to 10 wt. %, and the one or more fillers is from 15 wt. % to 45 wt. % of the total weight of the adhesive.

12. The adhesive according to claim 1, wherein the adhesive further comprises a lap shear strength from about 10 MPa to about 25 MPa, as measured according to the DIN EN 1465 standard on a cataphoretic dip-painted steel (CDP) substrate.

13. The adhesive according to claim 11, wherein the epoxide-functionalized acrylonitrile/butadiene copolymer is from 50 wt. % to 98 wt. % and the reaction product is from 2 wt. % to 10 wt. % of the total weight of the adhesive.

14. An adhesive, comprising:
an epoxide-functionalized acrylonitrile/butadiene copolymer having on average more than 1.5 epoxide groups per molecule; and
a reaction product of phthalic anhydride and diethylenetriamine,
wherein the reaction product is in ground form,
wherein the adhesive is meltable between 40° C. and 60° C. and thermally curable between 110° C. and 230° C., and
further wherein a ratio of the number of NH bonds in the reaction product of phthalic anhydride and diethylenetriamine to the total number of epoxide groups is between 0.1 and 1.5, as determined by using a theoretical equivalent weight of 77.7 g per mol of the NH bonds.

15. The adhesive according to claim 14, wherein the ratio of the number of NH bonds in the reaction product of phthalic anhydride and diethylenetriamine to the total number of epoxide groups is between 0.1 and 1.5, as determined by using a theoretical equivalent weight of 77.7 g per mol of the NH bonds.

16. The adhesive according to claim 14, wherein the ratio of the number of NH bonds in the reaction product of phthalic anhydride and diethylenetriamine to the total number of epoxide groups is between 0.5 and 0.9, as determined by using a theoretical equivalent weight of 77.7 g per mol of the NH bonds.

17. The adhesive according to claim 14, wherein the epoxide-functionalized acrylonitrile/butadiene copolymer is the product of a chemical reaction of a carboxyl-terminated acrylonitrile/butadiene copolymer with (a) a bisphenol A diglycidyl ether, a bisphenol F diglycidyl ether or an epichlorohydrin, and/or (b) a bisphenol A diglycidyl ether or a bisphenol F diglycidyl ether chain-extended by a chemical reaction with bisphenol A or bisphenol F.

18. The adhesive according to claim 14, wherein the adhesive further comprises a lap shear strength from about 10 MPa to about 25 MPa, as measured according to the DIN EN 1465 standard on a cataphoretic dip-painted steel (CDP) substrate.

19. The adhesive according to claim 18, wherein the epoxide-functionalized acrylonitrile/butadiene copolymer is from 50 wt. % to 98 wt. % and the reaction product is from 2 wt. % to 10 wt. % of the total weight of the adhesive.

20. An adhesive tape, comprising:
at least one carrier layer, the carrier layer comprising a woven fabric, a nonwoven, a paper or a film; and
the adhesive according to claim 14,
wherein the adhesive is disposed on the at least one carrier layer.
